(19) United States
(12) Patent Application Publication
(10) Pub. No.: US 2008/0145141 A1
(43) Pub. Date: Jun. 19, 2008

(54) Joint and/or Bearing Arrangement

(76) Inventors: Klaus Broeker, Bohmte-Hunteburg (DE); Jens Bach, Lembruch (DE)

Correspondence Address: MCGLEW & TUTTLE, PC, P.O. BOX 9227, SCARBOROUGH STATION, SCARBOROUGH, NY, 10510-9227, US

(21) Appl. No.: 11/574,924

(22) PCT Filed: Sep. 7, 2005
(86) PCT No.: PCT/DE2005/001566

§ 371 Date: Aug. 21, 2007

(30) Foreign Application Priority Data
Sep. 9, 2004 (DE) 10 2004 044 088.3

(51) Int. Cl. F16C 11/06; B62D 3/08

(52) U.S. Cl. 403/39; 280/86.756

(57) ABSTRACT

A joint and/or bearing arrangement (1) has a pivot (2) with a separate joint head (4) part, which can be held thereon and surrounds the pivot (2) in some areas. At least one equalizing channel (15) connects a space (13) located between the joint head (4) and a surrounding joint shell (5) to a space (14) located on the other side of the joint head (4) in respect to the radial extension of the pivot (2).

### CROSS REFERENCE TO RELATED APPLICATIONS

This application is a United States National Phase application of International Application PCT/DE2005/001566 and claims the benefit of priority under 35 U.S.C. § 119 of German Patent Application DE 10 2004 044 088.3 filed Sep. 9, 2004, the entire contents of which are incorporated herein by reference.

### FIELD OF THE INVENTION

The present invention pertains to a joint and/or bearing arrangement, as well as to a motor vehicle with one or more such joint and/or bearing arrangements, especially in chassis and/or steering components.

### BACKGROUND OF THE INVENTION

DE 44 03 584 C2 shows a ball and socket joint for use, e.g., in steering or chassis areas of motor vehicles, in which the joint ball has a through hole, is placed on a pivot stub with same and secured against being pulled off by a beaded edge of the pivot end. The components are secured against rotation in relation to one another by a longitudinal profiling of the outer and inner surfaces of the pivot and the inner surface of the ball. The provision of a means for securing against rotation and of the beading require a considerable manufacturing effort. The problem arises that an overpressure, which may lead to deformation or even bursting of the joint shell, which frequently consists of a plastic, will develop in the area between the joint ball and the joint shell, especially in case of the use of a chromium-free corrosion protection, which becomes necessary in light of ever-increasing requirements on disposal, along with the fact that it is now necessary to heat-treat the joint ball and to use a proper, less free-flowing lubricant during the mounting of the joint.

### SUMMARY OF THE INVENTION

The basic object of the present invention is to make it also possible to provide joints with good and environmentally friendly corrosion protection while mounting is simple and reliable.

According to the invention, a joint and/or bearing arrangement is provided comprising a pivot with a separate joint head which can be held on the pivot and surrounds the pivot in some areas at least close to its axial end. At least one equalizing channel is provided connecting a space located at least essentially outside an axial extension of said pivot and of the joint head to another space located on the other side of the joint head in respect to the axial extension of said pivot.

It is ensured in an embodiment according to the invention that no overpressure develops or a developing overpressure is eliminated in the space on the other side of the axial extension of the pivot and the joint head, so that damage to the joint shell or another component surrounding the joint head, which could occur especially during the mounting or even during the later operation, is reliably avoided.

If the space shown at the top in the drawings, which space is located on the other side of the axial extension of the pivot and the joint head, is limited only by the joint shell outside these components, this joint shell may be manufactured as an inexpensive complete component, e.g., as a one-piece injection-molded component with a uniform inner radius. As an alternative, an essentially ring-shaped joint shell would also be possible, and it would then be accommodated in a bracket limiting the space.

The equalizing channel or the equalizing channels may advantageously be used both to pass air through and to guide lubricant. It thus also becomes possible to use greases with very low free-flowing properties, which do not pass completely through the equalizing channels even during long-term operation and thus remain available for the mechanically stressed space between the joint head and the joint shell.

If the joint head consists of steel heat-treated on its surface, especially one treated in a nitriding process, good corrosion protection is guaranteed. Despite the additional surface hardness of the joint head resulting from this process, mounting is possible in a simple manner, if a means against securing, which would be deformed by the harder joint head, is not provided, but when the joint head is held by press fit on unstructured, round cylindrical area sections of the pivot without additional securing. The area sections may be interrupted by one or especially more, for example, four, even very thin equalizing channels with a radius of, for example, less than 1 mm each.

Optimized adaptation to the mechanical needs and an inexpensive manufacturing process are now made possible if the pivot consists of a material that was subjected to a treatment different from that of the joint head, for example, a heat-treatable steel without further surface treatment.

The assignment of the equalizing channel or equalizing channels to the pivot ensures that the joint head, which rubs against the joint shell during the operation and is therefore mechanically stressed, is not weakened.

In particular, a plurality of equalizing channels may be recessed as grooves in the circumferential surface of the pivot. Recessing the grooves axially is possible even during the manufacturing of the pivot according to the extrusion process without finishing by a machining operation. As an alternative or in addition, channels are also possible in the joint head or the joint shell, depending on the needs, which does, however, mean a weakening of the joint surface proper when plastic shells are used.

Such a joint may be stressed for both rotation about the axis of the pivot in the manner of a bearing and bending and thus it can be used in a versatile and tolerance-equalizing manner, for example, within chassis and/or steering components, for example, to support tie rods and push rods, which connect a respective wishbone to a torsion rod lying transversely in relation to the vehicle, as this is necessary, e.g., in the so-called McPherson axle.

Further advantages and features of the present invention appear from an exemplary embodiment of the subject of the present invention, which is shown in the drawings and will be described below.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of the joint according to the present invention;

FIG. 2 is a view similar to that in FIG. 1, but with an only partially cut-away pivot;

FIG. 3 is a view of the pivot from FIG. 1 with the joint head pressed thereon;

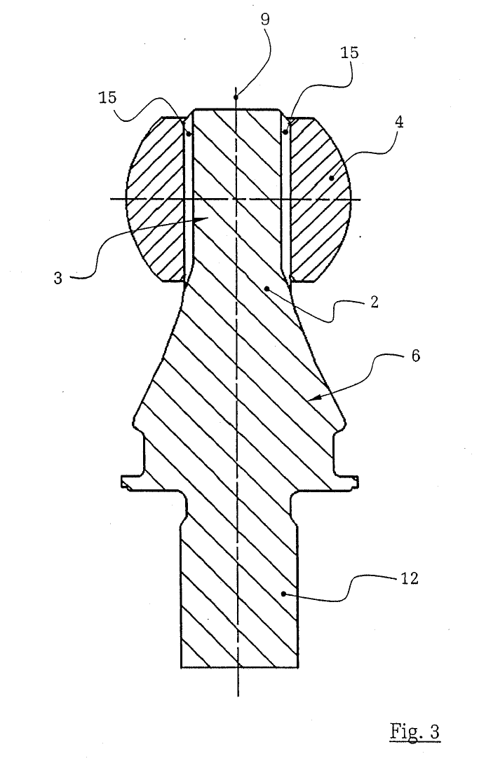

FIG. 4 is a view similar to that in FIG. 3, but showing the pivot partially cut-away; and

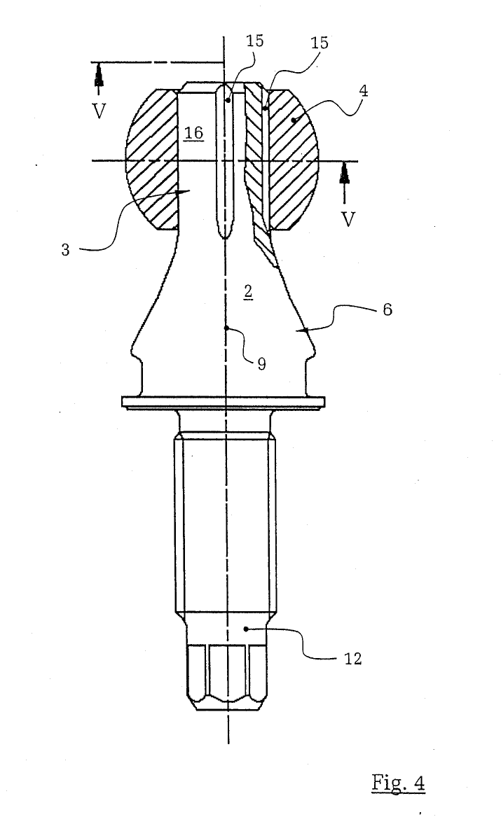

FIG. 5 is a sectional view along line VI-VI in FIG. 4.

### DESCRIPTION OF THE PREFERRED EMBODIMENTS

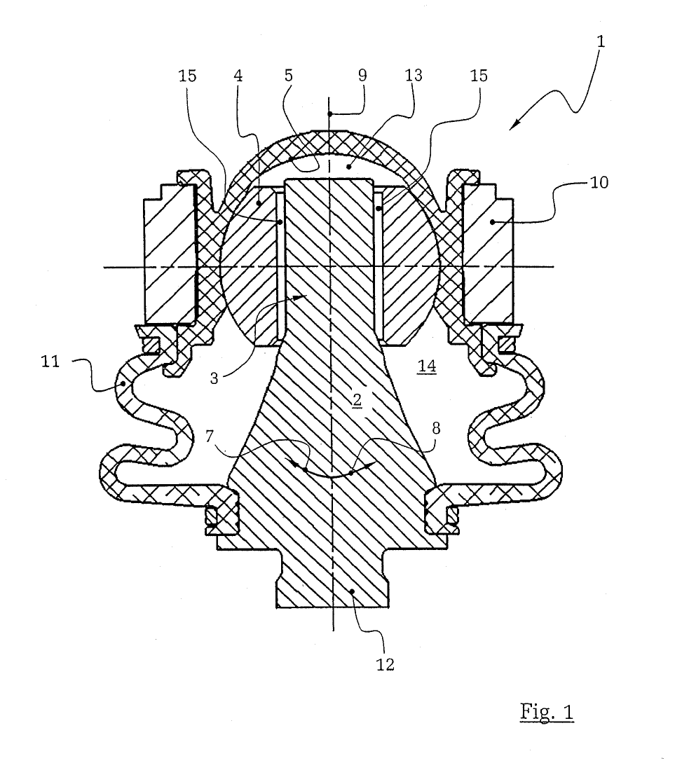

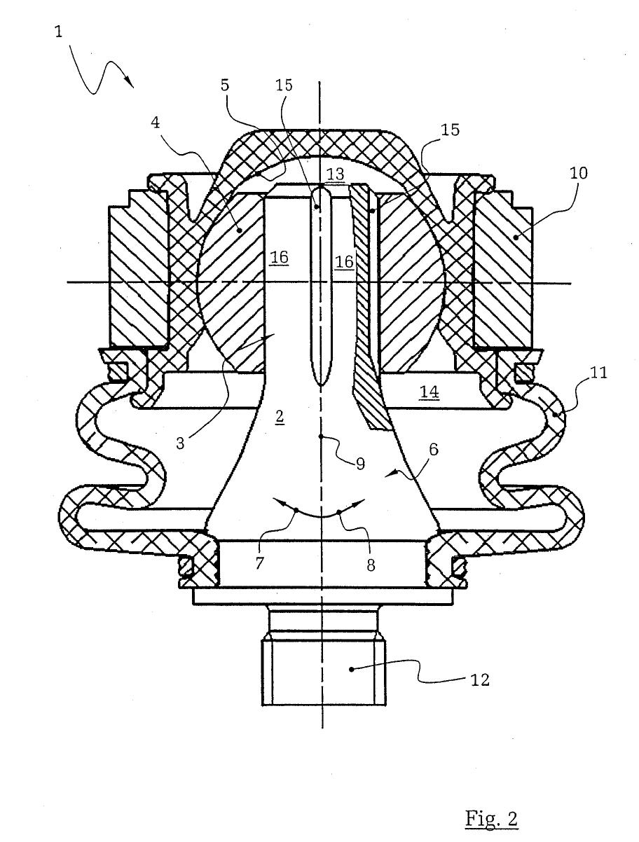

Referring to the drawings in particular, the joint 1 shown completely in FIGS. 1 and 2 comprises a pivot 2, onto which a joint head 4, here a joint ball, is pressed in an essentially round cylindrical neck area 3.

The pivot 2 can be manufactured according to an extrusion process without machining and consists, for example, of heat-treatable steel, here a 32CrB4 steel, without special surface heat-treatment. The joint head 4, which is a separate part before its mounting, can likewise be manufactured simply and at low cost without machining and has a flattened spherical shape on two mutually opposite areas with a through hole extending at right angles to the flattened areas, with which it surrounds the pivot 2 in the mounted position. Other outer shapes of the joint head, for example, also a round cylindrical or truncated cone shape, are also possible in case of corresponding needs. The joint head 4 may be subjected to surface treatment in order to better withstand loads in frictional contact with the surrounding joint shell (bearing shell) 5 during continuous operation and especially to have good corrosion resistance. It consists, for example, of a 38MnB5 steel and was additionally subjected to salt bath nitriding here. Another nitriding or another surface heat-treatment process is possible as well. The surface hardness of the joint head 4 also increases with the very good corrosion protection of the surface of the joint head 4, which is achieved by the nitriding, so that a means securing against rotation, as is encountered in the state of the art, would undergo deformation during the assembly of the joint head and the pivot, unless the pivot were also hardened, which would, however, cause additional costs. The harder joint head 4 is therefore held in press fit on round cylindrical area sections 16 of the pivot 2 in one embodiment of the present invention, the pressing pressure being sufficiently high, so that an additional securing, e.g., beading of the pivot end, is completely dispensable.

The pivot 2 according to the exemplary embodiment has a diameter of 9 to about 15 mm in its neck area 3 holding the joint head 4 for typical applications in the area of the chassis and the steering of motor vehicles and may be, for example, conically expanded in its shoulder area 6 facing away from the joint head 4 to increase stability.

In the mounted state of the components the joint head 4 is held immovably in press fit on the neck area 3 of the pivot 2 and is mobile in relation to a surrounding joint shell 5, which may consist of a plastic to reduce the weight and the costs, and this motion may be both a deflection in the direction of the arrow 7 or 8 and a rotation about the axis 9 of the pivot 2. Such a joint arrangement can therefore act in the manner of a bearing and is also called here, in general, a joint and/or bearing arrangement. The joint shell 5 is bordered by a steel ring 10 for stabilization and for connection to other components, for example, control arms, tie rods and/or push rods or the like. The joint 1 is surrounded as a whole by a seal 11, so that the pivot 2 is also not accessible from the outside except for an accessible fastening end 12, for example, a screw head, and lubricant cannot escape. As an alternative to the closed joint shell 5, an essentially ring-shaped joint shell is also possible, which would now be accommodated, for example, in a not only ring-shaped bracket (steel ring 10), but in a bracket completely limiting the space 13 outside the axial extension of the pivot 2 and of the joint head 4.

The space 13 between the joint head 4 and the joint shell 5 is filled at least partially with a lubricant, which is used to reduce the friction between the contact surfaces of the joint head 4 and the joint shell 5. The lubrication may be provided, in particular, for the entire projected service life of the joint 1. A viscous lubricant with only low free-flowing property is used.

The space 13 located between the joint head 4 and the joint shell 5 surrounding same is connected according to the present invention to a space 14 located on the other side of the joint head 4 in respect to the axial extension of the pivot 2 via one equalizing channel 15 or—as is being shown here—a plurality of equalizing channels 15. Four equalizing channels 15, which are of the same type and are distributed uniformly over the outer circumference of the neck area 3, are provided for connecting the spaces 13 and 14 in the exemplary embodiment being shown. They are recessed as grooves in the circumferential surface of the pivot 2 in the neck area 3 thereof and extend each axially linearly with a radius of somewhat less than 1 mm here with the total diameter of the neck area 3 being about 9 mm. Another, e.g., spiral or wavy course is also possible. The number of channels 15 is also variable, depending on the viscosity of the lubricant and depending on the cross-section area of the particular channel 15. The channels 15 can take up an excess quantity of lubricant and/or draw off an overpressure developing during the mounting between the shell 5 and the joint head 4 into the space 14. It is ensured due to the low free-flowing property of the grease that the grease will not readily flow completely through the channels 15 and is diverted into the space 14.

As an alternative to the channels 15 distributed over the circumference, an axial central hole would, for example, also be possible in the pivot 2 with channels leading transversely outwardly into the space 14. As an alternative or in addition, it is also possible, for example, to associate one or more channels with the joint head 4. However, this joint head is, as a rule, subject to a high stress in a small space, so that weakening of the material is more advantageous in the pivot 2 than in the joint head 4. At any rate, damage to the thin-walled joint shell 5 during mounting or the later operation, for example, in case of a temperature rise, due to overpressure of the lubricant or air, is prevented from occurring by the at least one equalizing channel 15.

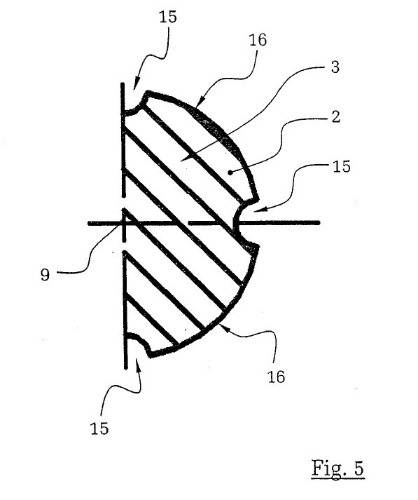

Outside the grooves 15, the neck area 3 has a completely round cylindrical outer circumference 16, as it is visible, for example, in the cross-sectional view according to FIG. 5. The joint head 4 can therefore be held, as was already suggested above, on the unstructured area sections 16 between the grooves 15 by press fit, without profiling being necessary there. It is thus also possible to mount a joint head 4 that has a markedly greater hardness than the pivot 2.

If the grooves 15, extending axially, pass through the pivot 2, as is shown here, up into the transition area from the parallel-walled neck area 3 to the shoulder area 6, which is conically expanding here, the stability of the pivot 2 increases under bending stress about its axis compared to a pivot that is manufactured without grooves 15 and is otherwise the same, as this is demonstrable on the basis of FEM (finite element) calculations. The improvement is on the order of magnitude of nearly 10% with the materials and dimensions being specified here.

While specific embodiments of the invention have been shown and described in detail to illustrate the application of the principles of the invention, it will be understood that the invention may be embodied otherwise without departing from such principles.

1. A joint and/or bearing arrangement comprising:
a pivot;
a separate joint head held on said pivot and surrounding said pivot in some areas close to is an axial end thereof, an equalizing channel connecting a space located at least essentially outside an axial extension of said pivot and of said joint head to another space located on the other side of said joint head in respect to the axial extension of said pivot.

2. A joint and/or bearing arrangement in accordance with claim 1, further comprising a surrounding joint shell, wherein said space located at least essentially outside the axial extension of said pivot and of said joint head is completely limited by said surrounding joint shell, besides by said joint head and said pivot.

3. A joint and/or bearing arrangement in accordance with claim 1, wherein said joint head consists of a surface-heat-treated steel.

4. A joint and/or bearing arrangement in accordance with claim 3, wherein said joint head is treated in a nitriding process.

5. A joint and/or bearing arrangement in accordance with claim 3, wherein said pivot consists of a material treated differently from said joint head.

6. A joint and/or bearing arrangement in accordance with claim 1, wherein said at least one equalizing channel is used for pressure equalization.

7. A joint and/or bearing arrangement in accordance with claim 1, further comprising lubricant wherein said equalizing channel is used to guide said lubricant.

8. A joint and/or bearing arrangement in accordance with claim 1, wherein at least one said equalizing channel is associated with said pivot.

9. A joint and/or bearing arrangement in accordance with claim 1, wherein at least one further equalizing channel is provided to form a plurality of equalizing channels recessed as grooves in a circumferential surface in a neck area of said pivot.

10. A joint and/or bearing arrangement in accordance with claim 9, wherein said grooves extend axially.

11. A joint and/or bearing arrangement in accordance with claim 1, wherein the joint and/or bearing arrangement can be stressed for both rotation about the axis of the pivot and for bending.

12. A joint and/or bearing arrangement comprising:
a pivot
a separate part joint head, held said pivot and surrounding said pivot at least in some sections, thereof, an equalizing channel being defined connecting a space located at least essentially outside an axial extension of said pivot and of said joint head to another space located on the other side of said joint head in respect to the axial extension of said pivot wherein at least the surface of said joint head consists of a material that is harder than the pivot surface and said joint head is held in press fit on unstructured, round cylindrical area sections of said pivot without additional securing.

13. A joint and/or bearing arrangement in accordance with claim 1, further comprising a seal surrounding both said spaces, which are connected by said equalizing channel lubricated for a calculated service life.

14. A motor vehicle chassis and/or steering component, comprising:
a steering or chassis part;
a pivot;
a joint head connected as a separate part to said pivot and held on said pivot and surrounding said pivot in some areas adjacent to an axial end of said pivot, said joint head with said pivot being movable mounted to said steering or chassis part, said pivot and said joint head cooperating to define an equalizing channel providing a through space connecting a head end space located at least essentially outside an axial extension of said pivot and of an axial extension of said joint head to another space located on the other side of said joint head in respect to the axial extension of said pivot.

15. A motor vehicle according to claim 14, further comprising:
a bearing shell connected to steering or chassis part, said joint head being mounted in said bearing shell, said space located at least essentially outside the axial extension of said pivot being completely limited by said surrounded by said bearing shell.

16. A motor vehicle according to claim 15, further comprising: a sealing bellows connected between said steering or chassis part and said pivot.

17. A motor vehicle according to claim 16, wherein said joint head consists of a surface-heat-treated steel treated in a nitriding process and said pivot consists of a material treated differently from said joint head.

18. A motor vehicle according to claim 16, further comprising lubricant wherein said equalizing channel is used to guide said lubricant.

19. A motor vehicle according to claim 16, wherein at least one further equalizing channel is provided to form a plurality of equalizing channels recessed as grooves in a circumferential surface in a neck area of said pivot.

20. A motor vehicle according to claim 19, wherein said grooves extend axially.
